(19) United States
(12) Patent Application Publication
(10) Pub. No.: US 2009/0031226 A1
(43) Pub. Date: Jan. 29, 2009

(54) Method and System for Extending Task Models for Use In User-Interface Design

(75) Inventors: Rui Zhang, Beijing (CN); John R. Hajdukiewicz, Minneapolis, MN (US); Gopal Vaswani, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/829,597

(22) Filed: Jul. 27, 2007

(51) Int. Cl. G06F 3/00

(52) U.S. Cl. 715/762

(57) ABSTRACT

Described herein is a task modeling system configured to process a task model that is described by a task modeling notation. Further, the task modeling notation may provide for attaching the task model to a user interface description. The system comprises a computer readable storage medium containing program code, wherein the program code is executable by a processor to (a) generate a task tree from a task model, wherein the task tree comprises a plurality of interconnected task nodes, wherein the task model is described by a task modeling notation, (b) attach the task tree to a user interface description, (c) coordinate a state of the task tree with a state of the user interface, and (d) cause the state of the user interface to be updated as indicated by the state of the task tree, wherein the state of the user interface is updated by updating a graphical display of the user interface.

### FIELD OF THE INVENTION

The present invention relates to user interface, and more specifically, to task modeling for user interface design.

### BACKGROUND OF THE INVENTION

In the modern world, computerized user interfaces improve many facets of our lives. Users can shop, converse, research, etc. through user interfaces on their desktop or laptop computers, or even on their mobile phones. Moreover, such user interfaces can reduce the cost of doing business and expand the opportunities for businesses. Computerized systems incorporating user interfaces can often replace paid employees who previously were required to provide customer service. Moreover, by implementing user interfaces on the Internet, businesses can easily reach consumers throughout the world.

Unfortunately, providing a user interface on multiple platforms often involves repetitive programming. This may be true even when much of the provided functionality is identical across all platforms. For example, a company that has previously designed a login interface for a personal computer (verifying that a user has a valid account with the company, for instance) may be forced to re-create the interactive functionality for a mobile phone user interface, despite the fact that the previously designed user interface already provides the same interactive functionality. In particular, the program code for the interactive functionality is recreated so that it corresponds with the appearance of the mobile user interface (which is often simplified for the smaller screen). Accordingly, means for creating reusable user interface program code, for at least the functional aspects of a user interface, are desirable.

### SUMMARY

Task modeling may be considered as a type of Model Driven User-Centered Design (MD-UCD) or a variant of model driven engineering/design (MDE/MDD). MD-UCD is similar to MDD, except that the focus is on user-centered design rather than software development.

Disclosed herein is a task modeling system comprising a computer readable storage medium containing program code. The program code is executable by a processor to (a) provide a task modeling interface with which a user can create a task model, wherein the task model comprises one or more tasks, (b) bind the task model to a user interface, (c) provide the user interface to a user, (c) determine when the user interacts with the user interface, and (d) in response to user interaction with the user interface, execute one or more of the tasks, wherein executing the tasks updates the state of user interface.

The task modeling interface may take the form of a graphical user interface (GUI), a text editor, or other forms. The task modeling notation may allow a user to define various types of tasks such as abstract tasks, application tasks, and/or interaction tasks, among others.

Also disclosed herein is a method for processing one or more user interactions with a user interface. The visual aspects of the user interface may be defined in a user interface description comprising user interface widgets. The functionality of the user interface may be defined by at least one task model comprising one or more tasks. The method comprises (a) binding at least one of the tasks to at least one of the user interface widgets, (b) detecting a user interaction with one of the user interface widgets, (c) in response the user interaction, executing any tasks that are bound to the user interface widget with which the user interacted, wherein executing the tasks provides an indication as to whether or not the user interface should be updated, (d) if the user interface should not be updated, leaving the user interface as it is, and (e) if the user interface should be updated, updating the user interface.

Further disclosed herein is a task modeling system configured to process a task model that is described by a task modeling notation. Further, the task modeling notation may provide for attaching the task model to a user interface description. The system comprises a computer readable storage medium containing program code, wherein the program code is executable by a processor to (a) generate a task tree from a task model, wherein the task tree comprises a plurality of interconnected task nodes, wherein the task model is described by a task modeling notation, (b) attach the task tree to a user interface description, (c) coordinate a state of the task tree with a state of the user interface, and (d) cause the state of the user interface to be updated as indicated by the state of the task tree, wherein the state of the user interface is updated by updating a graphical display of the user interface.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

Presently preferred embodiments of the invention are described below in conjunction with the appended drawing figures, wherein like reference numerals refer to like elements in the various figures, and wherein:

FIG. 1 is a simplified organizational chart depicting roles, processes, tools, etc. in a user interface (UI) design process that utilizes task modeling;

FIG. 2A shows simplified pseudo code for a task model described using an exemplary task modeling notation;

FIG. 2B shows simplified pseudo code for a UI description defined using a UI modeling notation;

FIG. 2C illustrates a UI;

FIG. 3 is a simplified diagram illustrating a task tree representing a task model;

FIG. 4 is a simplified flowchart illustrating a method for processing a task tree;

FIG. 5 is another simplified diagram illustrating a task tree representing a task model; and

FIG. 6 is a simplified block diagram representing a display from a UI design system.

### DETAILED DESCRIPTION

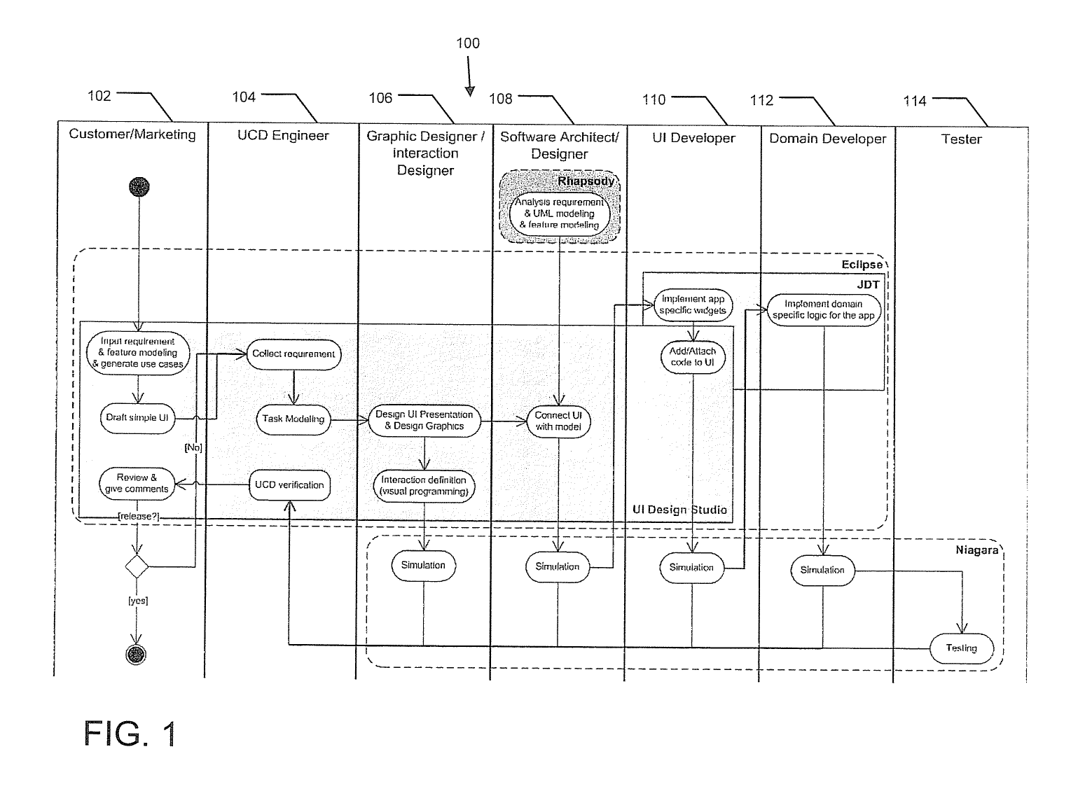

FIG. 1 is a simplified organizational chart 100 depicting roles, processes, tools, etc. in a user interface (UI) design process that utilizes task modeling. Generally, the parties are described herein as they are shown, from left to right. The parties may include (A) Customer Relation and/or Marketing personnel 102, (B) a User-Centered Design (UCD) Engineer 104, (C) a Graphic/Interaction Designer 106, (D) a Software Architect/Designer 108, (E) a UI Developer 110, (F) a Domain Developer 112, and (G) a Tester 114, among others. Note that in various embodiments, combinations or sub-combinations of these parties may carry out the UI design process. Additional parties may contribute to the process, and further, the responsibilities of the described parties may vary.

Marketing personnel 102 are responsible for gathering information from those who will ultimately use the UI design tool (e.g., customers, etc.). These personnel may gather required inputs/outputs for the UI and formulate a general idea of the features required by the user interface. In addition, those in the Customer/Marketing role may generate use cases, which illustrate how the user interface will be used in various scenarios. Further, Customer/Marketing personal may draft or sketch a simple UI.

The work of the Customer/Marketing personnel can then be used as a template by a UCD engineer 104. In particular, a UCD Engineer may use information and/or requirements produced by Marketing/Customer Interaction personnel to create task models. In particular, the UCD engineer may use the task modeling tool to create task models. The task modeling tool and may take the form of a visual tool such as a graphical user interface (GUI), or may take the form of a text based tool where the task model is created using a task modeling notation.

Graphic and/or Interaction Designers 106 (generally referred to as “UI designers”) may design the visual aspects of a UI. Preferably, the Graphic/Interface Designer creates a UI model or description in a UI design system. At this stage, the user interface is aesthetically designed, but may not be fully functional, as the program code providing the functionality for the UI may not have been implemented. Thus, UI developers 110 and/or domain developers 112 may implement the functionality envisioned by UI designers using various programming languages. However, functionality may be implemented by associating a UI description with a task model or task models. A task model may involve programming (which is tied to tasks as indicated using the task modeling notation). However, the total amount of programming involved in creating a UI may be reduced by the use of task models. In particular, once a task model and the underlying program code are created for a particular task, UI developers need not re-create the program code for the task in each UI they design.

To associate a task model with a UI, tasks may be attached to UI widgets (e.g., UI pages, UI forms, UI elements, etc.). A task modeling notation may include notations with which a task modeler or UCD engineer can designate a UI widget or widgets to which a task corresponds. As a result, task models can provide commonly used functions for UI designers, which can be reused in various UIs. For example, many different types of user interfaces involve a login interface. While a login interface may provide similar functionality on a cell phone and a personal computer, a login interface may differ visually on each device. On a cell phone, the display is usually much smaller, and the processor is generally not as powerful, as compared to a personal computer. Accordingly, a login interface on a cell phone may not be as graphically intense. However, the same task model may be attached to both the login UI for a cell phone and the login UI for a personal computer, providing the same login functionality for both devices.

In another aspect, a task engine may be provided to execute task models. The task engine may execute a task model at runtime of the UI with which the task model is associated. To execute task model at runtime, the task engine may interpret and execute the task model. Alternatively, the task engine may generate program code from a task model (which further may be compiled prior to runtime). The program code can then be executed according to user interaction with the associated UI.

More specifically, a UI designer may describe a UI by creating a UI description. The UI description may be created using a UI modeling notation, a visual UT programming system (which may translate visual UI models into UI models in the UI modeling notation), or using other means. The UI description may include UI widgets or objects that have various properties. The UI designer may attach or bind a UI widget or UI form to a task by setting a property of a widget or form to indicate a task. For example, in a visual UI design system, the user may simply drag and drop a task on the visual representation of a UI widget or form. Alternatively, if the UI description is being created using a UI modeling notation, the UI modeling notation may define how a UI widget or form is attached to a task or task model.

When a UI is executing and the user interacts with a UI, a UI engine may notify the task engine of the interaction that occurred. For example, when a user interacts with a UI widget, and the UI widget is attached to a task, the interaction may cause the task engine to execute program code carrying out the functionality associated with the task. If necessary, the task engine may compile and execute program code to carry out the task. Alternatively, program code associated with the task may be compiled prior to run-time. In such embodiments, a task engine may simply execute the program code to carry out the task.

A task model may be created using various means. For example, a modeler familiar with the task modeling notation may create a task model in any text editor (e.g., Microsoft Notepad, Microsoft Work, or a specific task modeling interface, for instance). The task model may also be created or edited using a graphical user interface (GUI) that allows a modeler to create visual task models that can be translated into task models defined by the task modeling notation. Task models may be created using a task modeling notation. Further, if a task model is created visually, the task engine may be configured to interpret the visual task model and generate a corresponding task model in the task modeling notation.

According to an exemplary task modeling notation, the modeler may include abstract tasks, which may include other tasks (including both abstract tasks and other types of tasks). The task modeling notation may include various other types of tasks. For example, an abstract task may include a number of “interaction” and/or “application” tasks that describe the functionality of the task model. Completion of interaction tasks may involve both user and computer actions, while application tasks may involve computer processing only. User tasks, on the other hand, may be completed by the user, without involving a computer. User tasks may simply be made available to the user and not executed by the task engine. Other types of tasks may also be defined.

Tasks may include various properties or attributes. For example, a task may include a “name” property and/or an “id” property for identification purposes, a “ui” property that indicates a UI object to which the task is attached, and/or a “method” property that associated a process with the task, among others. The task modeling notation may also be used to define relationships between tasks. Preferably, the task modeling notation defines temporal relationships between tasks, although other types of relationships may additionally or alternatively be defined.

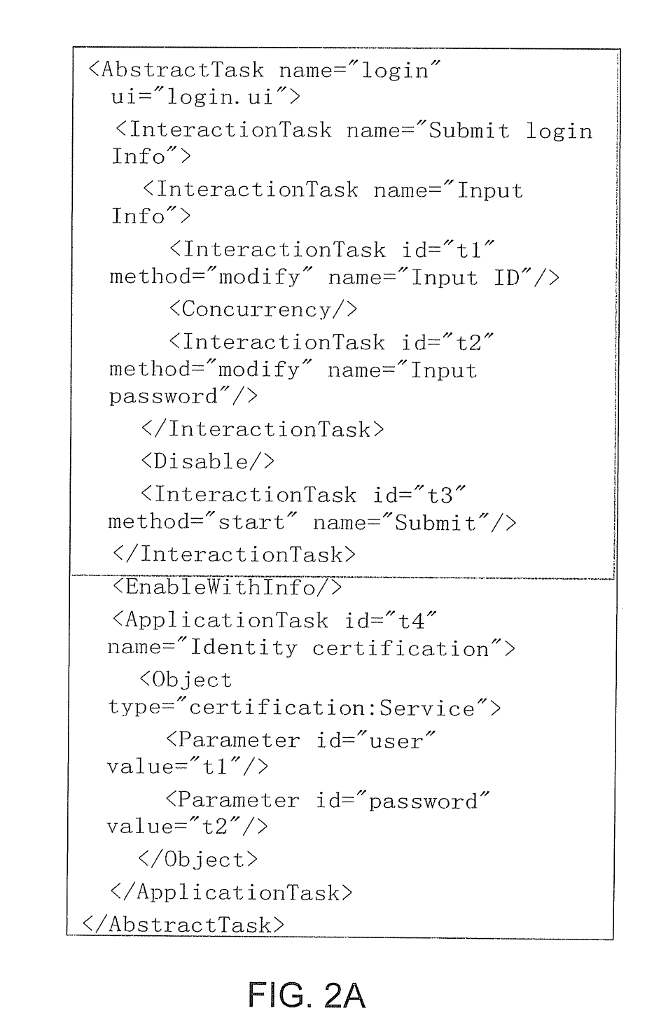

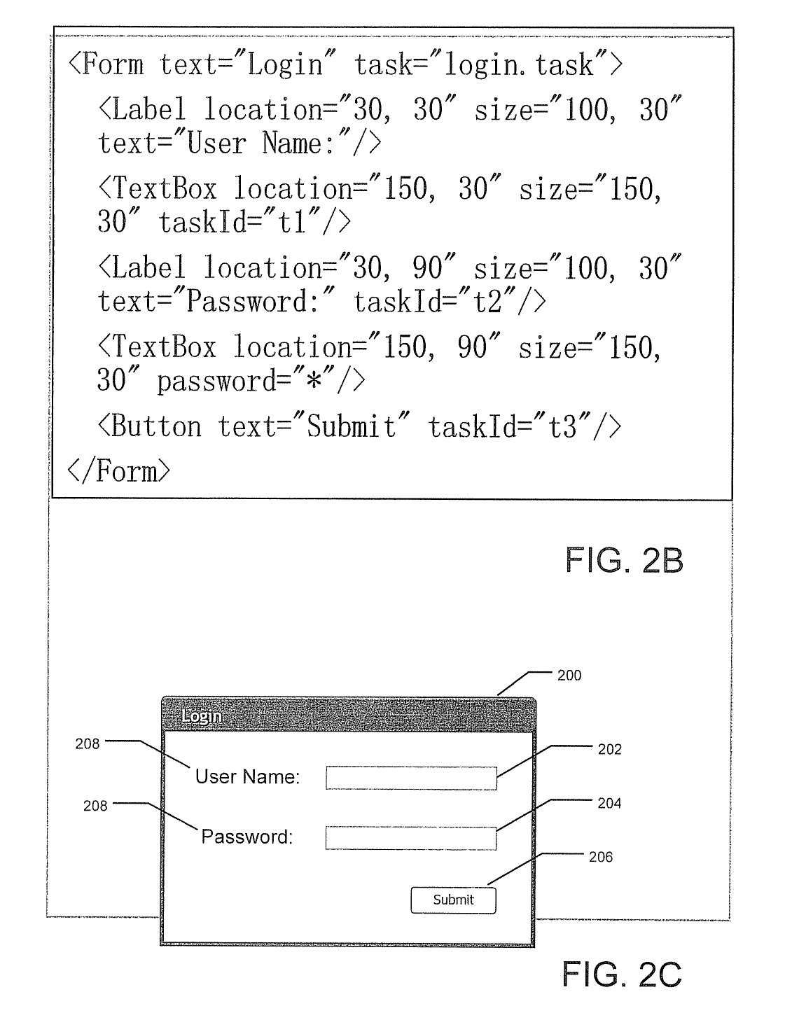

FIG. 2A shows simplified pseudo code for a task model described using an exemplary task modeling notation. In the depicted example, the code contained between the <AbstractTask name=“login” ui=“login.ui”> notation and </AbstractTask> notation defines the abstract “login” task. The “ui” property attaches the login task to a UI object described by the “login.ui” file. (Note that the “.ui” file extension or any type of appropriate file extension may be used to identify UI description files.) The functionality provided by the login task is defined using interaction and application tasks.

In particular, the illustrated login task includes interaction tasks named “submit login info,” “input info,” “input ID,” “input password,” and “submit,” and the application task and named “identity certification.” Each interaction task is defined using the notation <InteractionTask . . . > to indicate where content of the interaction task begins, and the notation </InteractionTask> to indicate where content of the interaction task ends. Similarly, each application task is defined using the notation <ApplicationTask . . . > to indicate where the content of the application task begins, and the notation </ApplicationTask> to indicate where the content of the application task ends.

The tasks may include various properties or attributes. For example, the “input ID,” “input password,” “submit,” and “identity certification” tasks include an ID property (e.g. “t1”-“t4”), which can be used to associate the task with a UI widget or form. Each task may also include a method property such as “modify” or “start.” Further, a method property may be a runtime support attribute providing a mechanism for reflection (i.e., retrieving the real address in memory of a method or property).

The task model may also include relationships between the tasks. For example, a <Concurrency/> relationship (which may be represented by the symbol “|||”) between the Input ID task, and the Input Password task indicates that these tasks may facilitate interactive capabilities at the same time or separately. The <Disable/> Relationship (which may be represented by the symbol “[>>”) between the Input Info task, and the Submit task indicates that if the methods specified by the input ID or the input password tasks are being performed the submit task is not enabled (i.e., the task cannot be interacted with by a user). Similarly, the <EnableWithInfo/> relationship (which may be represented by the symbol “[ ]>>”) between the Submit task and the Identify Certification task indicates that the Identity Certification task is enabled after data has been entered for the Submit task.

FIG. 2B shows simplified pseudo code for a UI description defined using a UI modeling notation, which describes an exemplary UI illustrated in FIG. 2C. The “login” UI form 200 is described between the <Form text=“login” task=“login.task”> and </Form> notations. The login form includes a task property, represented by the task=“login.task” notation, that binds the login form to the login.task file (e.g. the abstract login task). The login form also includes a text property, described by the text=“Login” notation, which results in the “Login” text being displayed on the login form 200.

The login form 200 includes a number of UI widgets, which may include various properties. Properties may include characteristics such as the size, the location, the format, and/or the task to which the widget is bound, among others. For example, the Text Box widget described by the <TextBox location=“150, 30” size=“150, 30” taskId=“t1”> notation is displayed at the location designated by the coordinates (150, 30) on a graphical display, has the dimension of 150×30, and is bound to the Input ID task. The Text Box widget described by the <TextBox location=“150, 90” size=“150, 30” password=“*” taskId=“t2”> notation is displayed at the location designated by the coordinates (150, 90) on the graphical display, has the dimension to 150×30, displays the character “*” rather than the text entered by the user, and is bound to the Input Password task. The Label widgets described by the <Label location=“30, 30” size=“100, 30” text=“User Name :”/> notation and by the <Label location=“30, 30” size=“100, 30” text=“Password :”/> notation each have the dimensions of 100×30, are located at the coordinates (30, 30) and (30, 90), respectively, and display the text “User Name :” and “Password :”, respectively. The login form, also includes a Button widget, described by the <Button text=“Submit” taskId=“t3”/> notation, which displays the text “Submit” and is bound to the Submit task.

In another aspect, a task engine may be configured to process or interpret task models. The task engine may interpret the model at runtime or may generate code in one or more of various programming languages. Further, the task engine may generate a visual representation of the task model which may be used for manipulating the task model. In particular, a visual representation of a task model may be used in UI design system to link UI descriptions with test models (e.g., by dragging and dropping the visual display of a task over the visual display of a UI widget, for instance).

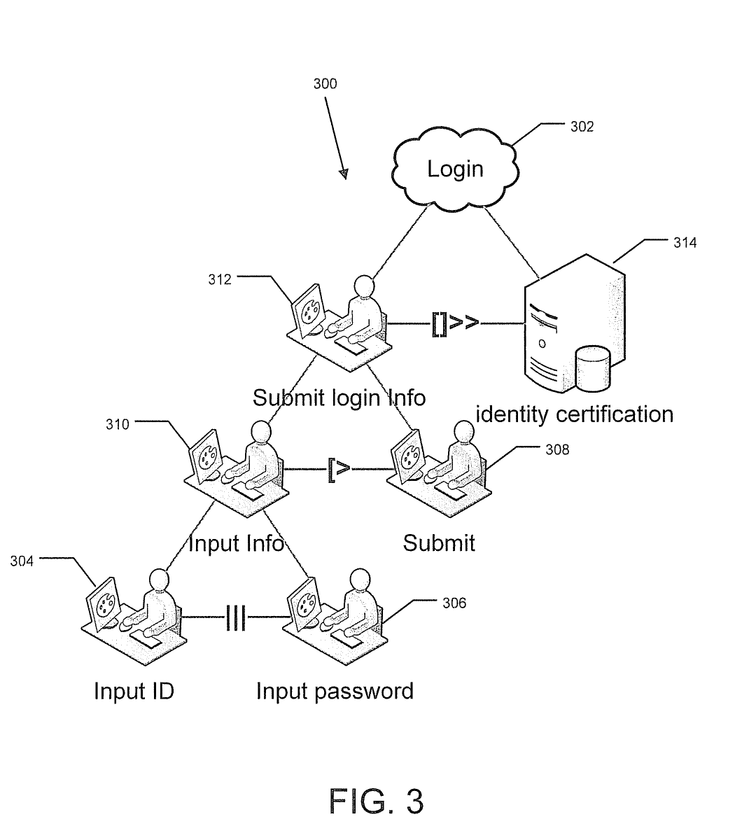

To process a task model, the task engine may create a tree structure (also referred to as a task tree), which captures the tasks included in the task model, as well as the relationships between these tasks. FIG. 3 is a simplified diagram illustrating a task tree representing the task model of FIG. 2A. A task tree 300 may be created by a task engine. The login node 302, representing the abstract login task, is the root node of the task tree 300. Nodes 312, 314 represent the Submit Login Info task and the Identity Certification task, respectively, and both depend from the Login task node 302. Similarly, nodes 310, 308 represent the Input Info task and the Submit task, respectively, and depend from the Submit Login Info node 312. Further, nodes 304, 306 represent the Input ID task and Input Password task, respectively, and depend from the Input Info task node 310.

The temporal relationships between tasks may be represented by various symbols. For example, the “[ ]>>” symbol represents the <EnableWithInfo/> relationship between the Submit Login Info task and the Identity Certification task, the “[>” symbol represents the <Disable/> relationship between Input Info task and Submit task, and the “|||” symbol represents that concurrency relationship between the input ID node and input password node. It should be understood that these symbols are only examples, and any appropriate symbols may be used. Further, the depicted task tree is for explanatory purposes, and thus, such symbols may be unnecessary, as the functionality of relationships may be captured by the task modeling notation.

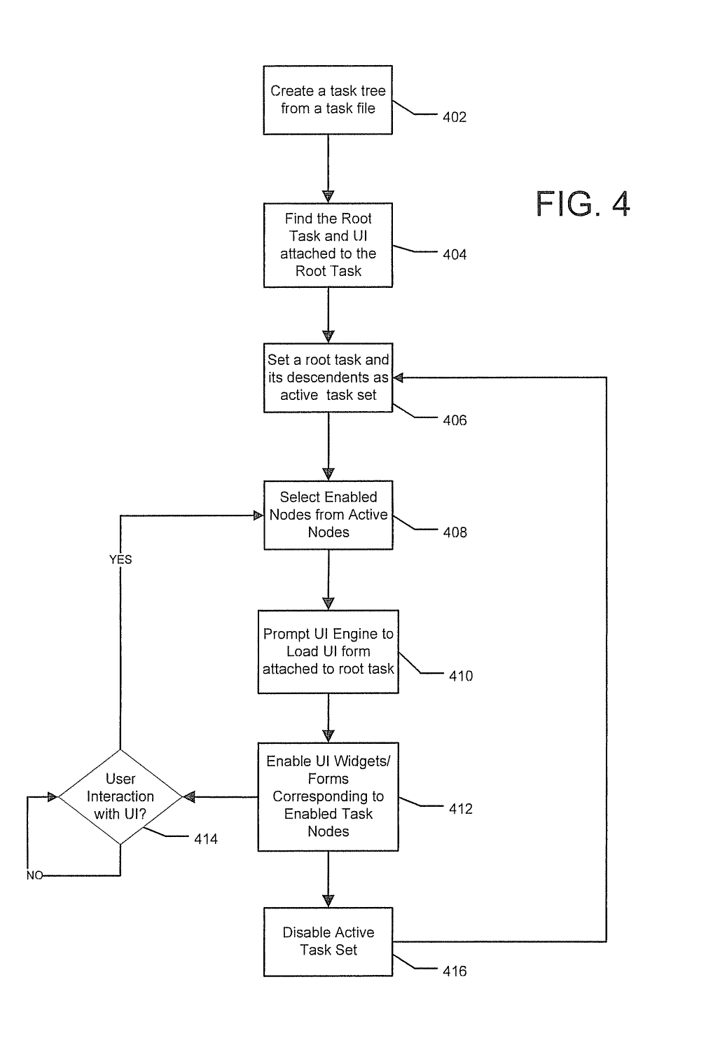

FIG. 4 is a simplified flowchart illustrating a method 400 for processing a task tree (at runtime or otherwise). First, the task engine creates a task tree from a task file (e.g., such as the login.task file), as shown by block 402. The task engine traverses the created task tree to find the root node or task, and the UI file that is attached to the root task, as shown by block 404. In order to find the root node, the task engine may traverse the task tree using various algorithms, such as a head ordered traversal algorithm, among others. More specifically, the head ordered traversal may be applied to abstract tasks, executing abstract tasks in an order dictated by the head order traversal algorithm. The task engine then sets the root task and its descendents, as active nodes to be processed by the task engine, as shown by block 406.

The task engine may select an enabled node or nodes from the active nodes, as shown by block 408. In the example shown, the root login task is included in the enabled task set. Further, the enabled task set includes the Submit task, the Input ID task, and Input Password task. These tasks are added by first traversing the tree and locating the nodes furthest from the root, in this case, the Input ID and Input Password task. Since the Input ID and Input Password tasks have a <Concurrency/> relationship, both of these tasks are added to the enabled task set. The task engine then works back towards the root node of the task tree, processing the parent or parents of the node or nodes just added to the enabled task in set, in this case, the Submit task and the Input Info task.

The task engine may then prompt the UI engine to load the UI form attached to the active task set, as shown by block 410. Then, as shown by block 412, the UI engine may enable those UI widgets and/or forms from the UI description that are attached or correspond to enabled task nodes. For example, the UI engine may attach the login form (described by the login.ui file) to the login task node. The TextBox widget with taskId=“t1” may then be attached to the Input ID task node, the Label widget with taskId=“t2” may be attached to the Input Password task node, and so on.

Enabling a UI form may results in display or rendering of the UI on a graphical display. Further, the user may interact with those UI widgets that are enabled. Thus, when the login form is enabled, a UI, such as that shown in FIG. 2C, may be displayed. In the UI, the user may be able to enter their username and TextBox 202 and their password and TextBox 204. Further, the user may be able to click the Submit Button 206, to submit their username and password.

After the UI engine loads a UI description into memory, the UI engine sets the widget's status in the active UI according to the current enabled task set. Therefore, taskIds, T1, T2, and T3 are enabled (i.e., the two text boxes, and the submit button, are enabled). The UI form is then rendered on a graphical display. The user can then interact with the UI form, using various input devices (e.g., mouse, keyboard, etc.).

When the user interacts with widgets in the UI form, the UI engine will notify the task engine of the interaction. Alternatively, the task engine may itself monitor the UI form for user interaction. In either scenario, when a user interacts with the particular widget, the task that is attached to that widget will be invoked by the task engine. For example, when the user enters their username and password in the text boxes, the input ID task and input password task may be invoked.

Returning to FIG. 4, the task engine may update the enabled task set in response to user interaction with the UI, as shown by block 414. The enabled task set may be identified using the relationships between nodes in the task tree. In particular, the task engine may iterate through blocks of 408-414 to update the enabled task nodes and/or the enabled UI widgets. For instance, when the user clicks the Submit button on the login form, the task engine may disable the Input Info task (and accordingly, the tasks depending from the Input Info task—the Input ID task and the Input Password task), as indicated by “[>” relationship between the Input Info task and the Submit task. At this point, the only enabled task may be the Identity Certification task.

It should be understood that the user may provide user input via any type of human interface device. For example, a user may provide input using a mouse and or a keyboard. As another example, the user may provide speech input via a microphone. Other examples are also possible.

Since the Identity Certification task 314 is an application task (and does not involve the user), the task engine will invoke the Identity Certification task when it is enabled. In particular, an application task may be sent to an application server that provides the appropriate functionality for the task. If the functionality for a particular object type requires an output. The application server may return to the task engine, output in various forms (such as an object of the same or different type as the object sent to the application server, for instance). For example, the Identity Certification task includes a service certification object, as indicated by the <Object type=“certification:Service”> notation. The server certification object includes two parameters, a user parameter (as described by the <Parameter id=“user” value=“t1”/> notation) and a password parameter (as described by the <Parameter id=“password” value=“t2”/> notation). The value property for each parameter indicates the task via which the user provides an input, in this case, the Input ID and Input Password task. The inputted values for the user and password parameters are then passed to the application server for verification.

When the task engine has fully executed an abstract task, the active task set may be disabled, as shown by block 416. Disabling the active task set may also result in the UI engine unloading the active UI. An abstract task may be considered fully executed in a number of scenarios. For example, an abstract task to be considered fully executed when all application tasks have been executed, or simply when all tasks have been executed. Or even more simply, an abstract task may be considered fully executed when the task engine receives an instruction or itself generates an indication that execution is complete.

As a more specific example, when Identity Certification task is complete (i.e., when the application server returns an indication that these username and password are valid or invalid), meaning that all application tasks (in this case, the only application task) are complete, the task engine may recognize this state and disable active task set. Alternatively, the task engine may receive output from the application server that can be used to determine when a task is fully executed. For example, application server may indicate that a username and password are valid. Provided with such an indication, the task engine may disable the active task set. Alternatively, if the application server indicates that the username and/or password are invalid, the task engine may refrain from disabling active task set and simply perform the process of selecting an enabled task set (which in turn may enable the tasks providing the login interface, as provided by login.ui, allowing the user to attempt to enter the correct username and password).

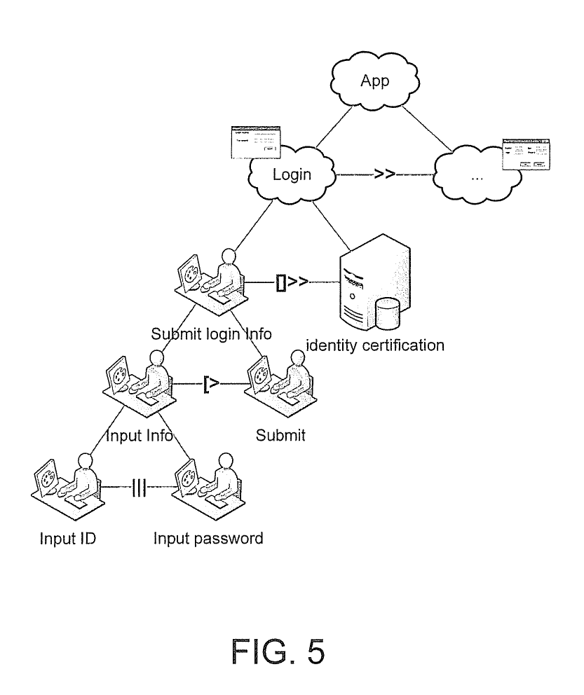

FIG. 5 is a simplified diagram illustrating a task tree representing a task model that includes the login task described in FIG. 2C. After the task engine disables the active task set for the login task node, the task engine traverses upwards towards the ultimate root node of the task tree. Accordingly, the task engine identifies the next abstract task to be processed, and processes this abstract task in a similar manner to the login abstract task. For example, the “>>” symbol indicates that the abstract task node 504 should be the root node of the new active task set.

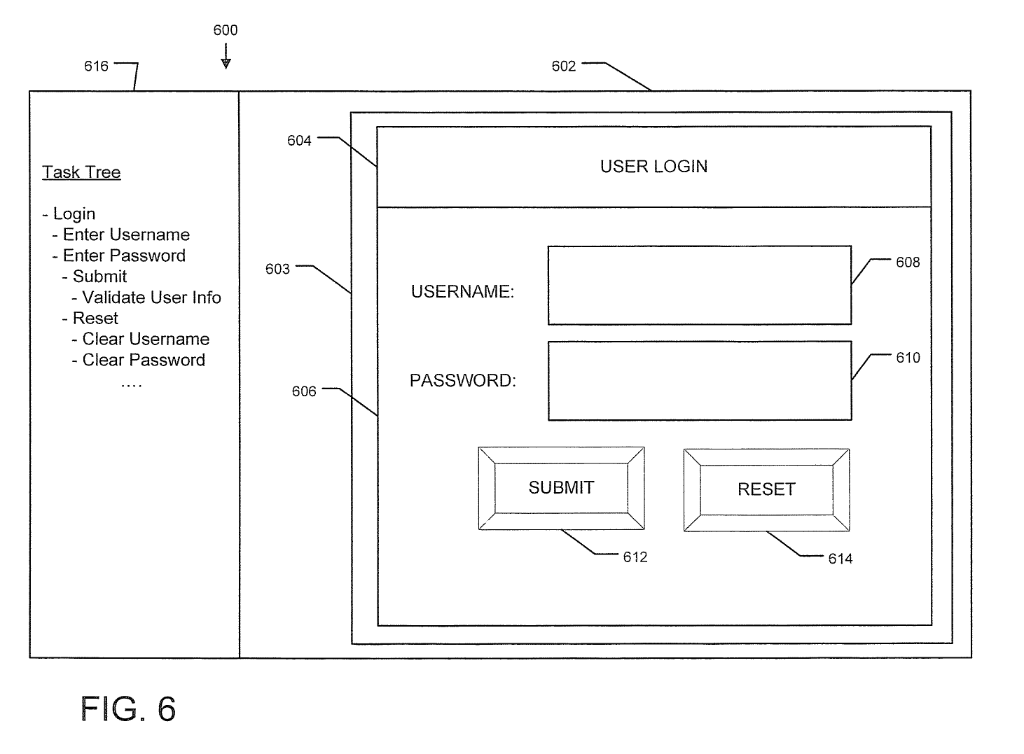

Preferably, a UI design system can integrate task modeling with UI design, so that a user can design tasks as well as UIs that integrate the tasks. For example, a UI design system, such as that described in co-owned U.S. Patent Application No. (07-095), may integrate task modeling with a UI design system. Advantageously, tasks may be reused in multiple UIs or in the UI designed for use on different devices or in different environments. For example, the “Login” tasks as illustrated in FIG. 6 and/or FIG. 2C could be used in designing a login UI in multiple formats (e.g. UI formatted for a PC, PDA, or a cellular phone).

FIG. 6 is a simplified block diagram representing a display 600 from a UI design system that may be used to create an executable UI. The graphical UI (GUI) design system includes a design panel 602, where the UI can be visually described by a user. The design panel 602 includes UI widgets 604-614, including UI page 603, UI forms 604, 606, and UI elements 608-614 (which may also be referred to as UI objects or components). Form 606 defines a windowpane for login functions and form 604 defines a title for the page: “User Login.” The UI elements may be of various types and have various properties. For example “Username” component 608 and “Password” component 610 are each a text box object, with a field for any text that is entered. “Submit” component 612 and “Reset” component 614 are each a button object, and have a field defining the name displayed by the button. The button objects 612, 614 may also have a field or property indicating when the button is pushed.

Display 300 may also include a task panel 316 that allows a user to bind tasks to a user interface. In particular, the user may bind tasks from task panel 316 to UI objects in the design panel 302 by dragging and dropping a task from the task panel onto an object in the design panel. Task panel 316 may be arranged in a task tree format, such that tasks are grouped by abstract task and/or by enabling task. Other arrangements are also possible. Task panel 616 illustrates a possible task tree for the “Login” abstract task 602 of FIG. 6.

In the illustrated example, the user may bind the UI form 603 to the “Login” abstract task, indicating the abstract task should be loaded when a user accessing UI form 603 (the “User Login” page). The user can then bind the “Enter Username” task to UI component 608 and the “Enter Password” task to UI component 610. As UI components 608, 610 are text box objects, text can be entered which serves as input to the “Enter Username” and “Enter Password” tasks. The user may bind the “Submit” task to the “Submit” button. 612 and the “Reset” task to the “Reset” button. 614. The tasks enabled by the “Submit” task and “Reset” task (“Validate User Info”, “Clear Username”, “Clear Password”) may also be bound to UI objects on the UI form 603 or another UI form. Alternatively, these tasks may be bound to a “hidden” UI object, which runs a task in the background (e.g., clicking “Submit” results in executing a non-visible object bound to “Validate User Info”). As another alternative, the user may have created the task model such that the functionality provided by “Validate User Info,” ensuring a username and password are correct, may be integrated with “Submit,” so that clicking the “Submit” button. 612 results in the validation of the username and password entered in “Username” component. 608 and “Password” component 610, respectively.

Provided with the presently disclosed task modeling notation and task engine, task models may be extended so as to reduce or eliminate the programming required for execution of tasks described by a task model. Further, the invention may help integrate task modeling and UI modeling, providing the flexibility of task modeling to UI designers. Many other benefits of the present invention will also be recognized by one skilled in the art.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. A task modeling system comprising:
a computer readable storage medium containing program code, wherein the program code is executable by a processor to:
provide a task modeling interface with which a user can create a task model using a task modeling notation; wherein the task model comprises one or more tasks;
bind the task model to a user interface;
provide the user interface to a user;
determine when the user interacts with the user interface; and
in response to user interaction with the user interface, execute one or more of the tasks, wherein executing the tasks updates the state of user interface.

2. The task modeling system of claim 1, wherein the task modeling interface comprises a graphical user interface (GUI).

3. The task modeling system of claim 1, wherein the task modeling interface comprises a text editor.

4. The task modeling system of claim 1, wherein the one or more tasks comprise one or more abstract tasks.

5. The task modeling system of claim 1, wherein the one or more tasks comprise one or more application tasks.

6. The task modeling system of claim 1, wherein the one or more tasks comprise one or more interaction tasks.

7. The task modeling system of claim 1, wherein the program code executable to bind the task model to a user interface comprises program code executable by the processor to bind one or more of the tasks to one or more widgets of a user interface description of the user interface.

8. The task modeling system of claim 1, wherein the program code executable by the processor to provide the user interface to a user comprises program code executable by a processor to present a graphical user interface on a graphical display.

9. The task modeling system of claim 1, wherein the program code executable by the processor to determine when the user interacts with the user interface comprises program code executable by a processor to receive input from at least one human interface device.

10. The task modeling system of claim 1, wherein the task modeling notation comprises notation for associating a task with program code that implements the task.

11. The task modeling system of claim 10, wherein the program code that implements a task comprises program code in a programming language, and wherein executing one of the tasks comprises:
compiling the program code in the programming language, wherein compiling the program code results in the creation of executable program code; and
executing the executable program code.

12. A method for processing one or more user interactions with a user interface, wherein visual aspects of the user interface are substantially described by at least one user interface description comprising user interface widgets, and wherein functionality of the user interface is substantially described by at least one task model comprising one or more tasks, the method comprising:
binding at least one of the tasks to at least one of the user interface widgets;
detecting that a user interaction with one of the user interface widgets;
in response the user interaction, executing any tasks that are bound to the user interface widget with which the user interacted, wherein executing the tasks provides an indication as to whether or not the user interface should be updated; and
based at least in part on the indication as to whether or not the user interface should be updated, updating the user interface.

13. A task modeling system configured to execute a task model described by a task modeling notation, wherein the task model comprises tasks that are attached to widgets of a user interface, wherein the user interface is described by a user interface description, the task modeling system comprising:
a computer readable storage medium containing program code, wherein the program code is executable by a processor to:
generate a task tree from a task model, wherein the task tree comprises a plurality of interconnected task nodes corresponding to the tasks;
attach one or more of the task nodes to one or more of the widgets;
coordinate a state of the task tree with a state of the user interface; and
cause the state of the user interface to be updated as indicated by the state of the task tree, wherein the state of the user interface is updated by updating a graphical display of the user interface.

14. The task modeling system of claim 17, wherein the program code executable by a processor to attach the task tree to coordinate a state of the task tree with a state of the user interface comprises program code executable by the processor to:
determine an active task set comprising task nodes from the task tree; and
from the active task set select currently enabled task nodes, wherein the currently enabled task nodes correspond to elements of the user interface description with which a user can interact with via the graphical display;
receive an indication of user interaction with the user interface; and
based at least in part on the indication of user interaction, update the enabled task nodes.

15. The task modeling system of claim 19, wherein the program code executable by a processor to cause the state of the user interface to be updated as indicated by the state of the task tree comprises program code executable by the processor to:
cause the user interface description to load, wherein loading user interface description results in display of the user interface on the graphical display;
execute program code that corresponds to the enabled task nodes, wherein the program code generates an output; and
use the output as a basis for causing the state of the user interface to be updated.
